(19) United States
(12) Patent Application Publication
(10) Pub. No.: US 2013/0331193 A1
(43) Pub. Date: Dec. 12, 2013

(54) Constant Velocity Universal Joint

(71) Applicants: Khalid A. Nassir, Amara (IQ); Ezdihar F. Fandi, Amara (IQ); Lewa A. Khalid, Amara (IQ); Shams A. Khalid, Amara (IQ); Yahya A. Khalid, Amara (IQ)

(72) Inventors: Khalid A. Nassir, Amara (IQ); Ezdihar F. Fandi, Amara (IQ); Lewa A. Khalid, Amara (IQ); Shams A. Khalid, Amara (IQ); Yahya A. Khalid, Amara (IQ)

(21) Appl. No.: 13/494,370

(22) Filed: Jun. 12, 2012

(51) Int. Cl. F16D 3/16

(52) U.S. Cl. 464/153

(57) ABSTRACT

In a universal joint, a connector member with jacket connects joint halves, each having a ball joint with first connection to the connector member; shaft with eccentric arm; and inner piece with first and second orthogonal axes. A second connection, rotary around the first axis, connects eccentric arm and inner piece. Shaft axis and first axis extend orthogonally. The ball joint has third connection to the shaft rotary around the shaft axis. Fourth connection, rotary around the second axis, connects inner piece and connector member. The first connection is rotary around an axis orthogonal to the second axis and in a common plane with the first axis. A pivot point of the ball joint is offset to the rotary axis of the first connection and the shaft axis. The inner piece extends through first or a second opening of the jacket. The fourth connection is placed within the jacket.

### FIELD OF THE INVENTION

The invention relates to a constant velocity universal joint, an articulated shaft with the constant velocity universal joint, and an axis for a motor vehicle comprising such an articulated shaft.

### BACKGROUND OF THE INVENTION

A universal joint, in general, is a mechanical coupling between two rotating shafts, used to transmit power, motion, or both. The axes of the shafts are always intersecting and the deflection angle between them is permitted to change during operation. The “Cardan joint” (also called “Hooke's joint”) is a well known example of a universal joint. It is noted that the Cardan joint transmits rotary motion but does not ensure that the angular velocities of the shafts are equal at all times.

A constant velocity universal joint, on the other hand, is a universal joint that transmits a rotary motion while keeping the angular velocities of the shafts equal at all times. True constancy of angular velocity transmission is achieved by a widely used arrangement of two Cardan joints in series as shown in US2006/0089202 A1, the output member of the first joint comprising the input member to the second joint. It is noted, however, that the constancy is kept only under strict geometrical requirements, both input and output shafts must lie in one plane and both deflection angles of the two Cardan joints must be kept equal at all times. This principle in the so called Double Cardan Universal Joint is described for example in U.S. Pat. No. 5,419,740, where two Cardan joints are connected by a relatively short intermediate member designed to meet said geometrical requirements.

Another known constant velocity universal joint, which is commonly used in motor vehicle front wheel drives, is the Rzeppa joint. It operates on the basic principle that constancy of transmission is ensured when the contact point or points between the two shafts lie in the so called “homokinetic plane” of the joint. This plane is normal to the plane defined by the two shaft axes. The Rzeppa joint consists of a cage that keeps six balls in the homokinetic plane at all times. A further development of the Rzeppa joint, which allows not only angular but also axial relative movement of the shafts, is described in U.S. Pat. No. 4,573,947. U.S. Pat. No. 7,121,950 B2 or WO 2005/042995 shows joints which achieve constant velocity with grooves or ball tracks.

U.S. Pat. No. 7,144,326 teaches to apply force in order to keep joint parts in the homokinetic plane. As an alternative U.S. Pat. No. 5,954,586 shows a joint which requires sliding parts and comprises first and second joint halves and a central connecting member for connecting said first and second joint halves with each other, each joint half comprising:
a first half of a ball joint with a connection with said central connector member,
a shaft with a shaft axis, comprising at its face side a fork,
an inner piece provided with a first inner piece axis and second inner piece axis, which are orthogonal to each other,
a connection rotary around the first inner piece axis between said fork and said inner piece,
a shaft trunnion with a first end at the face side end of said shaft and a second end forming a second ball joint half.

EP 2 270 350 A2 shows a constant velocity universal joint, comprising first and second joint halves and a central connector member for connecting said first and second joint halves with each other, each joint half comprising:
a first half of a ball joint with a connection with said central connector member,
a shaft with an eccentric arm which is eccentric to a rotation axis of said shaft,
an inner piece provided with a first inner piece axis and second inner piece axis, which are orthogonal to each other,
a connection rotary around the first inner piece axis between said eccentric arm and said inner piece,
a second half of said ball joint with a connection with the shaft which is rotary around said shaft axis,
a connection rotary around the second inner piece axis between said inner piece and the central connector member,
said connection of said first half of said ball joint with the central connector member being rotary around an axis, which is orthogonal to said second inner piece axis and in a common plane with said first inner piece axis,
a pivot point of the ball joint formed by said first and second joint halves being arranged with an offset to the axis of said connection between said first ball joint half and said central connector member and to said shaft axis.

### SUMMARY OF THE INVENTION

An object of the claimed invention is to enable constant velocity universal joints which are excellent under at least some of the following aspects, in particular:
1. maximum angle of deflection between the shafts
2. size and mass of the joint
3. constancy of velocity transmitted through the joint.
4. mechanical efficiency of the joint and
5. manufacturing cost.

The invention improves a constant velocity universal joint, comprising first and second joint halves and a central connector member for connecting said first and second joint halves with each other, each joint half comprising:
a first half of a ball joint with a connection with said central connector member,
a shaft with an eccentric arm which is eccentric to a rotation axis of said shaft,
an inner piece provided with a first inner piece axis and second inner piece axis, which are orthogonal to each other,
a connection rotary around the first inner piece axis between said eccentric arm and said inner piece, wherein the shaft axis and the first inner piece axis are arranged orthogonal with respect to each other,
a second half of said ball joint with a connection with the shaft which is rotary around said shaft axis,
a connection rotary around the second inner piece axis between said inner piece and the central connector member,
said connection of said first half of said ball joint with the central connector member being rotary around an axis, which is orthogonal to said second inner piece axis and in a common plane with said first inner piece axis,
a pivot point of the ball joint formed by said first and second joint halves being arranged with an offset to the axis of said connection between said first ball joint half and said central connector member and to said shaft axis.

The central connector member has a jacket and for each of said first and second joint halves the jacket has an opening, said inner piece extends through said opening so that the connection rotary around the second axis is placed within said jacket.

Since it has a jacket, the central connector member allows for employing a hollow structure which enables an excellent combination of advantageous mass and stability features for the joint.

The joint according to the invention can be embodied as a light weight construction, in particular so that, when mounted in a motor vehicle in the driving shaft, unsuspended masses are reduced and suspension comfort and/or driving safety is enhanced.

In each of said first and second joint halves of a preferred embodiment, said first half of said ball joint has a ball of said ball joint and said second half of said ball joint has a socket of said ball joint which is eccentric to said shaft axis. Said ball joint may have a trunnion inserted into a bore of said shaft.

Said jacket is preferably a cylindrical element. Said inner piece may have a pair of trunnions on said second inner piece axis which are inserted into recesses and/or openings housed by said jacket. Said central connector member has preferably a pair of symmetric bores on each of said second inner piece axis and said axis of said connection of said first half of said ball joint with the central connector member, which symmetric bores are part of said connection of said first half of said ball joint and of the connection rotary around the second inner piece axis, respectively. This central connector member may enhance manufacturing efficiency of the joint. The pair of symmetric bores may also be replaced by a through hole.

Preferably in each of said first and second joint halves said first half of said ball joint has a trunnion and is inserted with said trunnion into a bore of or into the through hole of said central connector member.

A preferred constant velocity universal joint according to the invention has a movement restriction for said connection rotary around said first inner piece axis, wherein in each of said first and second joint halves said inner piece has an arm extending from said connection rotary around said first inner piece axis into said opening of said central connector member and has a protrusion which extends diametrically opposed to said arm with respect to said first inner piece axis and said eccentric arm of said shaft has surfaces for abutting against said protrusion and said arm of said inner piece.

In each of said first and second joint halves of a preferred joint according to the invention said connection rotary around said first inner piece axis comprises
an eye of said inner piece,
a fork having two eyes at an end of said eccentric arm of said shaft and
a symmetric pair of blocks each of said blocks being inserted into said eye of said inner piece and one eye of said fork. This embodiment offers in particular manufacturing efficiency. In this embodiment, each of said eyes of said fork may have a groove and a snap ring inserted into said groove and may accommodate a cup of a needle bearing secured by said snap ring, each of said blocks being supported in each of said eyes of said fork with said needle bearing.

The invention provides also an articulated shaft having at least one constant velocity universal joint as described above and/or a front axis for a motor vehicle, comprising this articulated shaft.

By means of the first and second ball joint halves, the invention employs a crank shaft mechanism in order to space apart and maintain parts within the homokinetic plane.

The invention enables high deflection angles between the shafts like 100° or more. A deflection angle of 100° corresponds to ±50° inclination of the shafts from a state in which the shafts rotate on a common rotation axis. The invention's joint has high durability along with constant velocity. The invention enables joints which are excellent in particular based on combinations of the following aspects:
1) a high number of identical parts of the joint which in turn causes low manufacturing costs,
2) a high maximum angle of deflection between the shafts like in particular 100° (from +50° to −50°),
3) a torque transmission mechanism without sliding parts,
4) a high strength against externally imposed axial forces,
5) a low mass of the joint which causes in turn low manufacturing cost and low momentum during operation,
6) a high mechanical efficiency,
7) true constancy of velocity at all operating angles.

In particular, manufacturing cost may be saved, when the inner pieces, the forks, the first ball joint halves and/or the shaft trunnions of both joint halves are formed identically.

According to a further aspect, the socket of the ball joint may be formed by a recess like a hemispherical cavity which preferably has a radius which is equal to the radius of the ball. The shaft may have a bore bearing a trunnion of the first ball joint half.

The central connection member may have bearings, in particular needle bearings, within its jacket for accommodating trunnions of said inner piece on said second inner piece axis.

In the above mentioned embodiment having a pair of eyes at the eccentric arm and blocks for connecting the inner piece these blocks may be supported in needle bearings inserted into said eyes and secured in each eye with outer grooves and snap rings inserted into the outer grooves.

The following drawings and description illustrate a preferred embodiment of a joint according to the invention.

### BRIEF DESCRIPTION OF THE DRAWINGS

FIG. 1 is an exploded isometric view of parts of a constant velocity universal joint according to the invention.

FIG. 2.1 is a cross sectional view of the centering mechanism pieces of the joint shown in FIG. 1 illustrating their eccentricity as a distance between the parallel horizontal lines.

FIG. 2.2 is a top view of a shaft of the joint shown in FIG. 1 with an eccentric arm.

FIG. 2.3 is a cross sectional side view of the shaft shown in FIG. 2.2 with a blind hole to accommodate a needle bearing for a second ball joint half and with the eccentric arm having two eyes at an end.

FIG. 2.4 is a top view of an inner piece formed as an inner arm of the joint shown in FIG. 1.

FIG. 2.5 is a cross sectional side view of the inner arm shown in FIG. 2.4.

FIG. 2.6 is a top view of the central connector member of the joint shown in FIG. 1.

FIG. 2.7 is a cross sectional side view of the central connector member shown in FIG. 2.6.

FIG. 3.1 is an isometric view of the joint shown in FIG. 1 when the angle of inclination between the shafts is 0°.

FIG. 3.2 is an isometric view of the joint shown in FIG. 1 when the angle of inclination between the shafts is 30°.

FIG. 3.3 is an isometric view of the joint shown in FIG. 1 when the angle of inclination between the shafts is 50°.

FIG. 4 is an isometric view of the central connector member shown in FIGS. 2.6 and 2.7 assembled with the inner arms shown in FIGS. 2.4 and 2.5.

FIGS. 5.1 to 5.5 illustrate operation positions of a crank shaft mechanism formed with ball joints in the joint illustrated in FIG. 1.

FIG. 6 is a cross sectional view of ball joints of the joint shown in FIG. 1 which form a centering mechanism.

FIG. 7.1 shows an isometric view of the centering mechanism shown in FIG. 6.

FIG. 7.2 shows corresponding center lines of the centering mechanism shown in FIG. 6 and FIG. 7.1.

FIG. 8.1 shows two extreme positions of the inner arm with respect to the central connector member of the joint shown in FIG. 1.

FIG. 8.2 shows the two extreme positions of the inner arm with respect to the arm and shaft of the joint shown in FIG. 1.

FIGS. 9.1 to 9.3 illustrate the homokinetic plane and the plane of shaft axes of the joint shown in FIG. 1 at different angles of inclination between the shafts.

FIGS. 10.1 to 10.3 are cross sectional side views of the joint shown in FIG. 1 at an angle of inclination between the two shafts and at different angles of rotation of the two shafts.

### DESCRIPTION OF THE PREFERRED EMBODIMENTS

The constant velocity universal joint illustrated in the Figures comprises first and second joint halves and a central connector member 5 for connecting said first and second joint halves with each other. Each joint half comprises
a first half 4 of a ball joint with a first connection with said central connector member 5,
a shaft 9 with an eccentric arm 1 which is eccentric to a rotation axis A of said shaft 9,
an inner piece 2 which is an arm provided with a first axis B and second axis C, which are orthogonal to each other,
a second connection, rotary around the first axis B, between said eccentric arm 1 and said inner piece 2, wherein the shaft axis A and the first axis B are arranged orthogonal with respect to each other,
a second half 3 of said ball joint with a third connection with the shaft 9 which is rotary around said shaft axis A,
a fourth connection, rotary around the second axis C, between said inner piece 2 and the central connector member 5,
said first connection of said first half 4 of said ball joint with the central connector member 5 being rotary around an axis, which is orthogonal to said second axis C and in a common plane with said first inner piece axis B, and
a pivot point of the ball joint formed by said first and second joint halves 3, 4 being arranged with an offset to the axis of said fourth connection between said first ball joint half 4 and said central connector member 5 and to said shaft axis A.

The central connector member 5 of the constant velocity universal joint has a jacket and, for each of said first and second joint halves, the jacket has an opening 5c and the inner piece 2 has an arm 2d that extends through said opening 5c, and said fourth connection rotary around the second axis C is placed within said jacket of said central connector member 5.

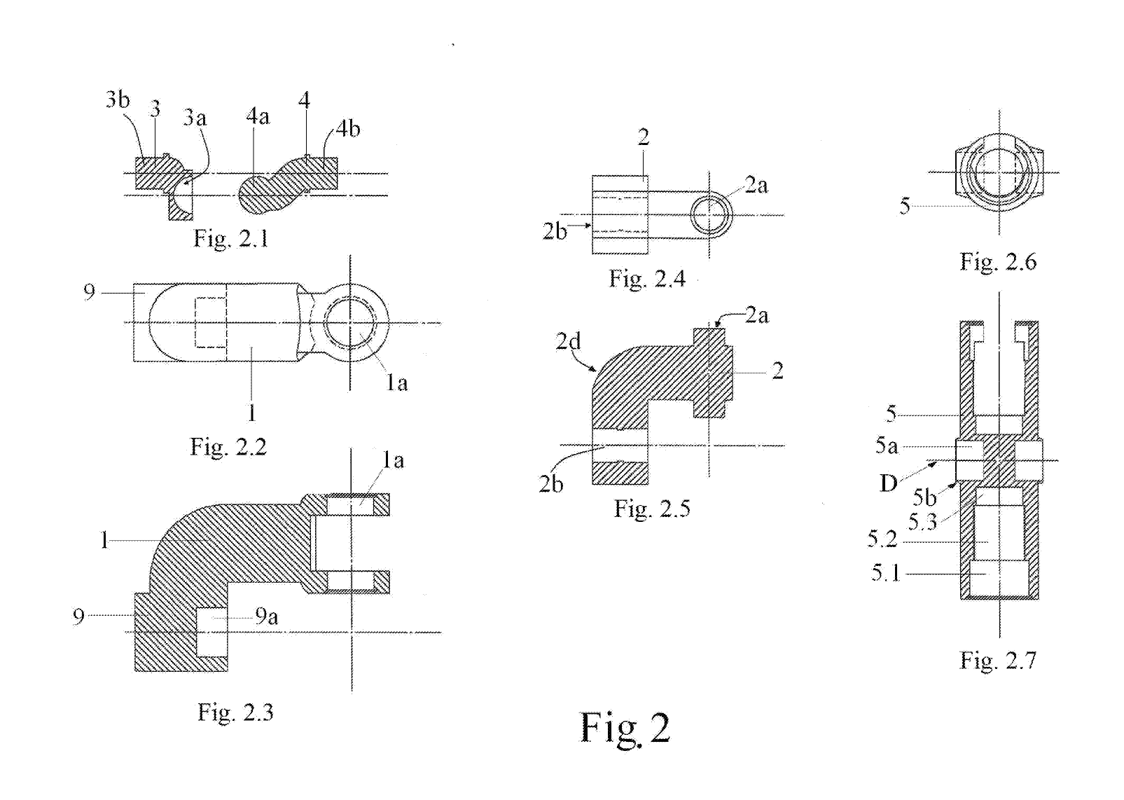

The shaft 9 has a central blind bore 9a formed coaxial to the shaft axis A and housing a needle bearing. The eccentric arm 1 is attached to the shaft 9 and has the same diameter as shaft 9. The eccentric arm 1 is designed to transmit the same torque as shaft 9. The eccentric arm 1 ends with a fork having two eyes 1a which surround the first axis B as illustrated in FIGS. 2.2 and 2.3. Each eye 1a accommodates via a needle bearing 10, 6 a cylindrical block 11 as a pin and consists of a pair of cylinders with different diameters. A pair of these blocks 11 is inserted into an eye 2b of the inner piece 2 to be placed and held in the eye 2b so that the center axis of the pair of cylinders is the same as the first axis B. The eyes 1a have a groove and a snap ring 8 is inserted into the groove to secure the needle bearings. The eye 2b of the inner piece 2 has a central inner circumferential protrusion for separating from each other the two blocks 11 of the pair of blocks inserted into the eye 2b.

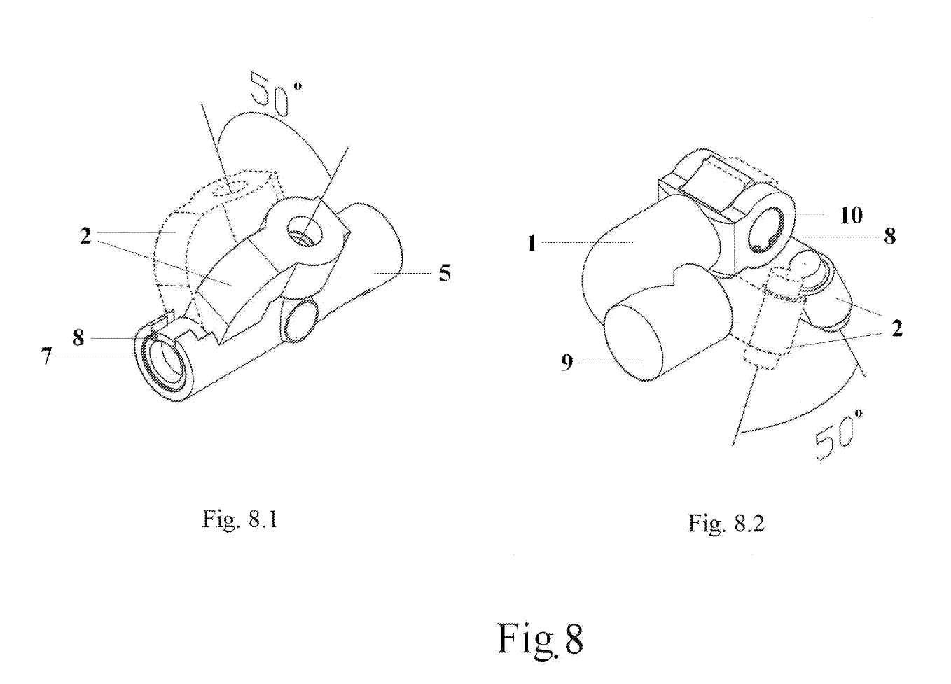

The inner piece 2 has an extruded portion or protrusion 2c forming a stopper to limit the angle of inclination up to 50° as illustrated in FIG. 8.2. The protrusion 2c extends diametrically opposed to the arm 2d with respect to axis B and the eccentric arm 1 of the shaft 9 has surfaces for abutting against the protrusion 2c and the arm 2d of the inner piece 2.

Thus, the inner piece 2 and the eccentric arm 1 interact to provide a movement restriction for the second connection rotary around said first axis B.

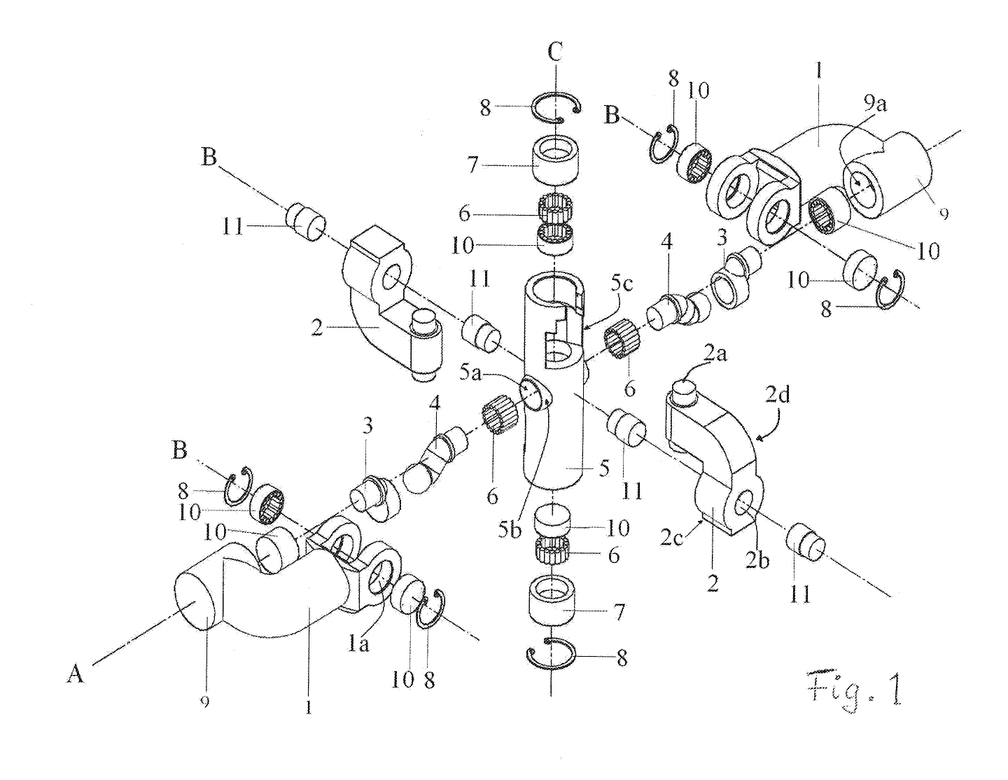

As shown in particular in FIG. 1 and FIG. 2.7, the central connector member 5 has a cylindrical shape around the second inner piece axis C and defines a jacket. The central connector member 5 has two aligned blind bores 5a with cylindrical walls 5b extending away from said jacket. The cylindrical walls 5b and the blind bores 5a are coaxial to an axis D orthogonal to axis B of said second inner pieces 2 such that the axis orthogonal to the axis B of said second inner piece 2 and the axis C of said second inner piece 2 cross each other at the center of the central connector member 5. The blind bores 5a with the cylindrical walls 5b house needle bearings 6 for bearing trunnions 4b of said first ball joint halves 4.

On the axis C the central connector member 5 has a pair of symmetric sets of three bores 5.1, 5.2, 5.3 and the diameters of these bores 5.1, 5.2, 5.3 narrow towards the center of the central connector member 5. Of these three bores, two receive needle bearings 6, 7, 10 with a cup 10 and a sleeve 7, respectively. Each of these needle bearings supports a trunnion 2a of the inner piece 2 of one of the joint halves. Of these three bores, the bore 5.2 between the two bores 5.1, 5.3 is provided with an opening 5c which is arranged in the jacket of the central connector member 5. Snap rings 8 in grooves near end faces of the central connector member 5 secure the sleeves 7. As illustrated in particular in FIGS. 2.7 and 8.1, the inner piece 2 has an arm 2b arranged between the trunnions 2a of the inner piece 2 which extends through the opening 5c and the opening 5c restricts a rotation angle for said inner piece 2 about the axis C up to 50°. Accordingly FIGS. 8.1 and 8.2 illustrate two extreme positions of the inner piece 2 with respect to the central connector member 5 at rotation angles around the second inner piece axis C of ±50°.

As illustrated in particular in FIG. 2.1, the first half 4 of the ball joint is a shaft with a collar and an eccentric ball 4a and the second half 3 of the ball joint is a shaft with a collar and an eccentric hemispherical cavity 3a. The diameter of the ball 4a is the same as that of the hemispherical cavity 3a. The eccentricity of the centering mechanism pieces 3a, 4a is visible in the cross sectional view of FIG. 2.1 as a distance D1 between the parallel horizontal lines.

An analysis of the joint illustrated shows two mechanisms:

1) A power transmission mechanism consisting of the shafts 9 with their eccentric arms 1 and their pairs of eyes 1a, the inner pieces 2 with their trunnions 2a, the central connector member 5, the blocks 11 and the needle bearings 6, 10, bearing said trunnions 2a and said blocks 11.

2) A centering mechanism consisting of the shafts 9 with their bores 9a and their eccentric arms 1 and their pairs of eyes 1a, said inner pieces 2 and said ball joints 3, 4 and the bores 5a for bearing the ball joints 3, 4 in the central connector member 5, the blocks 11 and the needle bearings 6, 10 bearing said blocks 11 and said ball joint halves 3, 4.

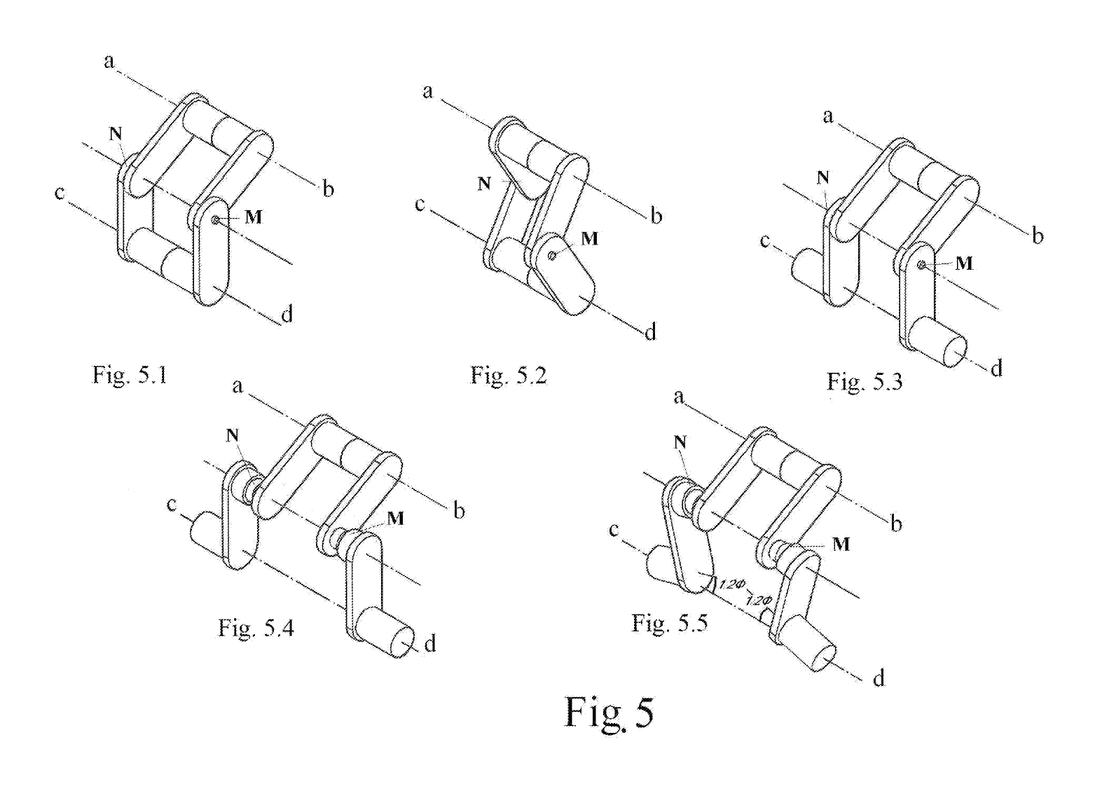

As illustrated in FIGS. 5, 6, 7, 9 and 10 for an angle of inclination φ, the origin O, which is also a center point of the central connector member 5, always coincides with the intersection points of the axes of both shafts 9. This is the case with all of the joint's operating angles due to the joint's geometry.

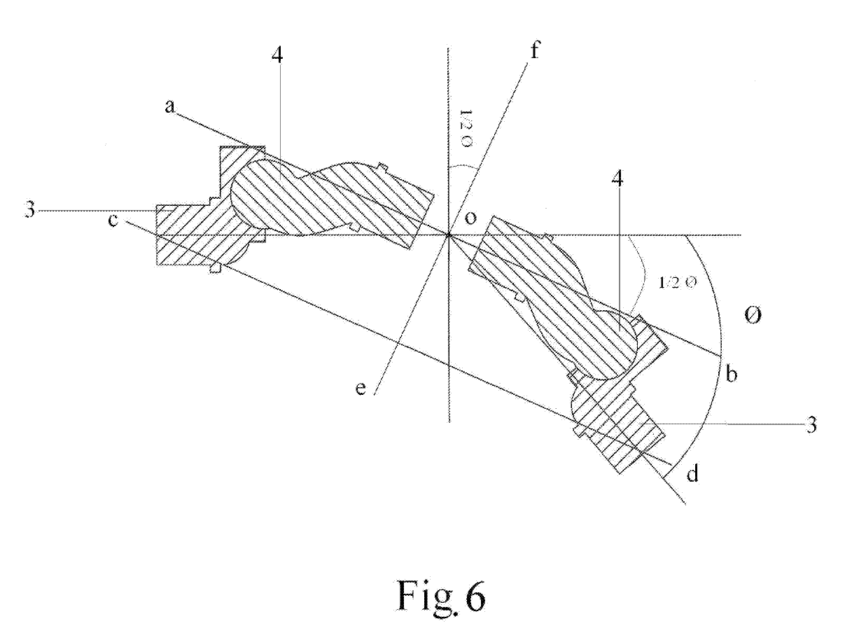

In the cross sectional view of the centering mechanism pieces of the joint of FIG. 6, an angle Ø between the two shafts 9 is illustrated. FIG. 6 shows a rotation axis a-b of the first ball joint halves 4, which extends through the central connector member 5. Further, a line c-d is shown, which extends through the bearings of the trunnions 3b in the second ball joint halves 3. Both lines define axes of a crank shaft mechanism. For the functioning of the joint's crank shaft mechanism in different angles of inclination, FIGS. 5.1 to 5.5 illustrate that the line a-b always runs parallel to the line c-d. The line e-f shown in FIG. 6 is orthogonal to the lines c-d and a-b and corresponds to the second axis C. The line e-f is always in a plane bisecting the angle φ between the shafts (homokinetic plane), such that the line e-f will always be in the homokinetic plane between both shafts 9 and the line a-b is normal to the homokinetic plane.

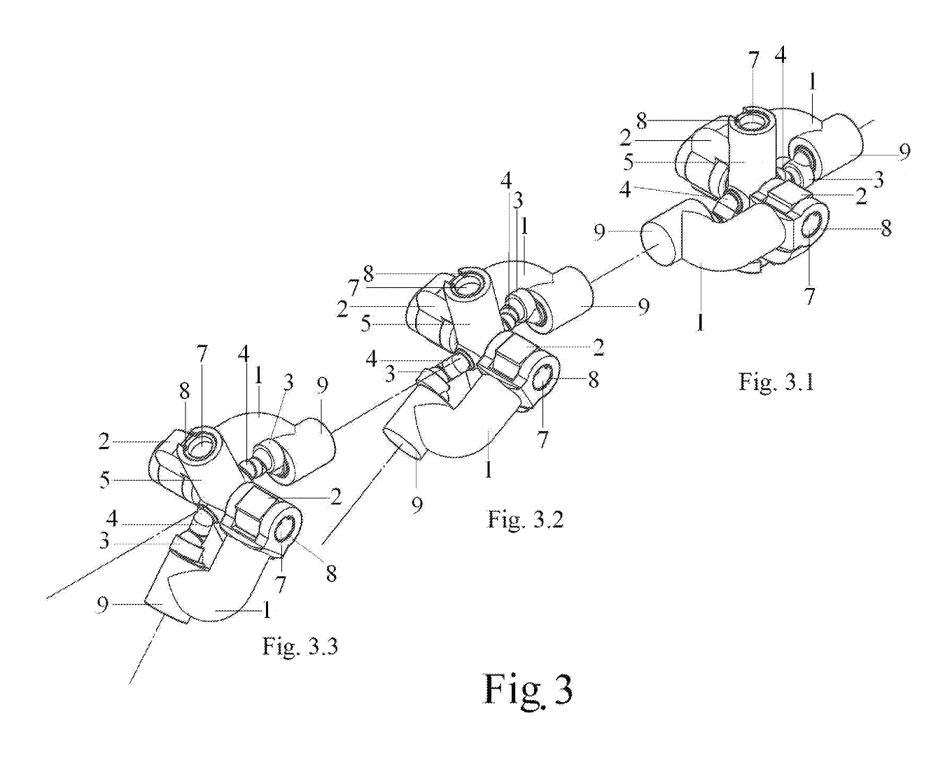

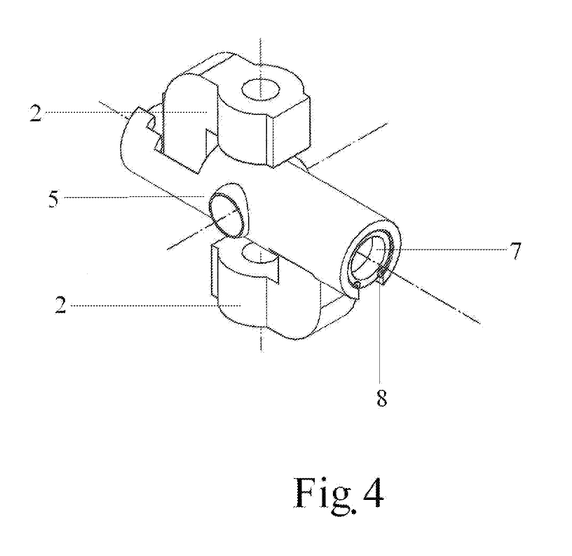

FIG. 3.1 illustrates in an isometric view of the joint an angle of inclination between the shafts 9 of 0°. FIG. 3.2 illustrates in the isometric view of the joint an angle of inclination between the shafts 9 of 30°. FIG. 3.2 illustrates in the isometric view of the joint an angle of inclination between the shafts 9 of 50°.

FIGS. 5.1 to 5.2 illustrate pin joints N, M, in FIG. 5.3 lower shafts are directed outwards. FIG. 5.4 illustrates a replacement of the pin joint M, N shown in FIG. 5.3 by a ball joint. FIG. 5.5 illustrated tilting of the lower shafts shown in FIG. 5.4 with equal angles of ½ Ø.

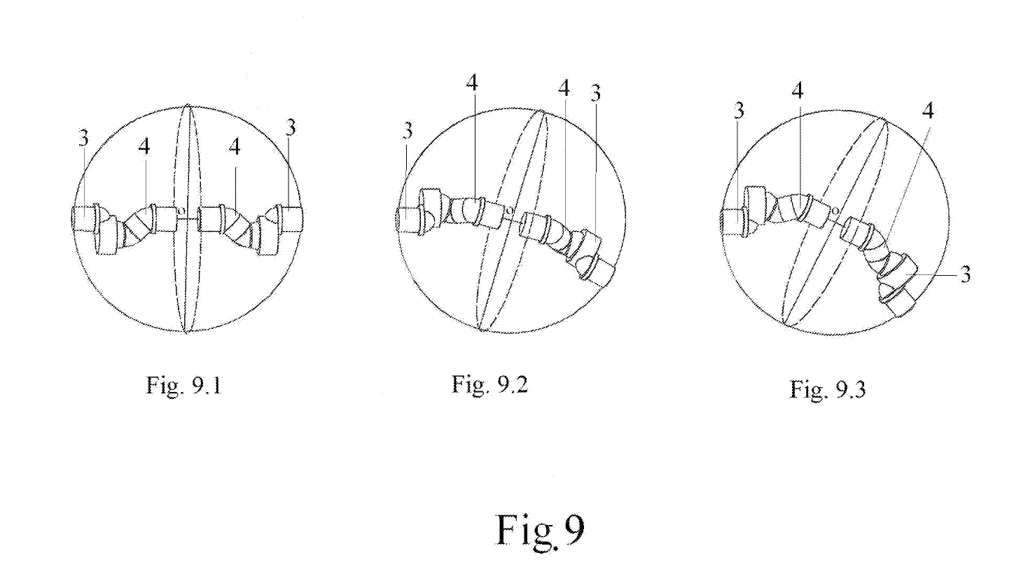

FIG. 9.1 illustrates the joint at an angle of inclination between the shafts 9 of 0°. This means that the shafts 9 are aligned. FIG. 9.2 illustrates the joint at an angle of inclination between the shafts 9 of 30°. FIG. 9.3 illustrates the joint at an angle of inclination between the shafts 9 of 50°. In FIGS. 9.1 to 9.3 the circle shown in dashed line represents the homokinetic plane of the joint while the circle shown in solid line represents the plane of shafts axes. The planes of the two circles are normal to each other.

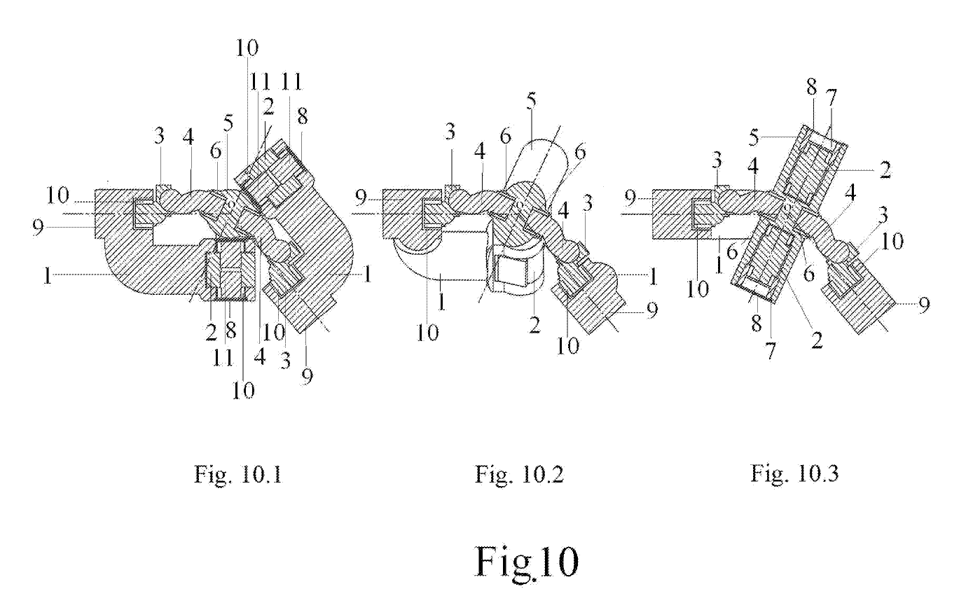

FIG. 10.1 illustrates the joint at an angle of rotation of the two shafts 9 around the axis A shown in FIG. 1 of 0° and of axis C of the central connector member 5 shown in FIG. 1 of 0°. In FIG. 10.2 the angle of rotation of the two shafts is 42°, while the angle of rotation of the axis C of the central connector member 5 is 45°. In FIG. 10.3 the angle of rotation of the two shafts is 90°, while the angle of rotation of the central connector member 5 is 90°.

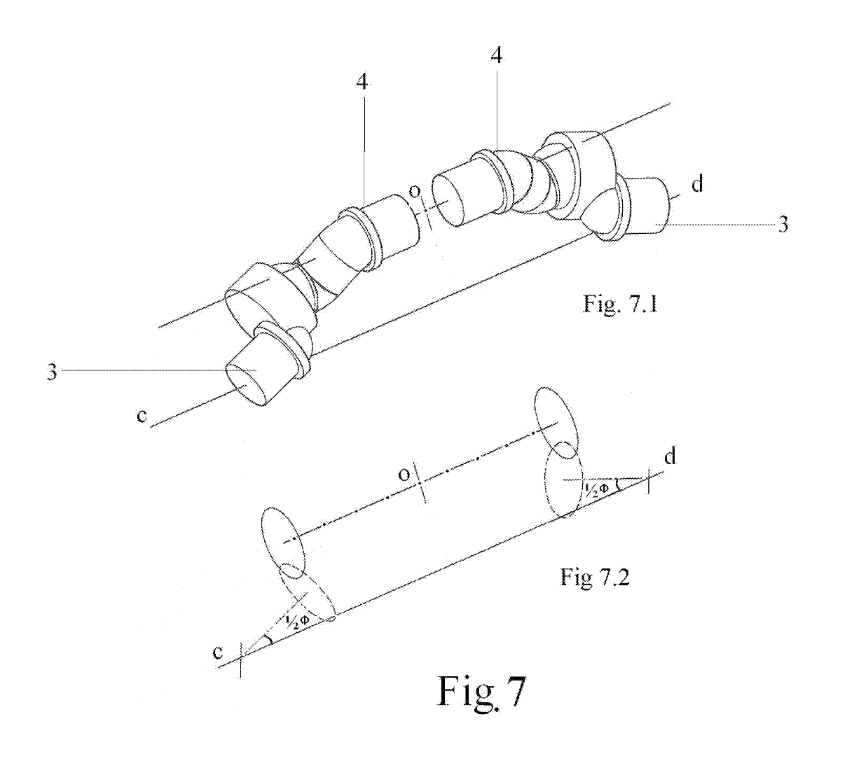

FIG. 7.2 illustrates lines for determining the described inclination and rotation angles in the illustrated joint.

The needle bearings 6 in the central connector member 5 reliably absorb radial forces.

The dimensions of each part of the joint, in particular the length and diameter of the pins, eyes, trunnions and forks can be modified according to the stress which is imposed due to the torque transmitted by the joint.

The maximum angle of inclination of the illustrated joint is ±50° based on the oppositely arranged two inner pieces 2.

The illustrated joint permits an excellent combination of the features of compactness and lightness and only extremely small momentums occur and the joint is easy to assemble and manufacture.

What is claimed is:

1. A constant velocity universal joint, comprising first and second joint halves and a central connector member connecting said first and second joint halves with each other, wherein said central connector member has a jacket with a first opening associated with said first joint half and a second opening associated with said second joint half, each one of said first and second joint halves comprising:
a ball joint having a first half and a second half,
said first half of said ball joint provided with a first connection with said central connector member,
a shaft with an eccentric arm which is eccentric to a rotation axis of said shaft,
an inner piece provided with a first axis and a second axis, said first and second axes being orthogonal to each other,
a second connection, rotary around said first axis, between said eccentric arm and said inner piece, wherein said rotation axis of said shaft and said first axis are arranged orthogonal to each other,
said second half of said ball joint provided with a third connection with said shaft, said third connection being rotary around said rotation axis of said shaft,
a fourth connection, rotary around said second axis, between said inner piece and said central connector member,
said first connection of said first half of said ball joint with said central connector member being rotary around a rotary axis extending orthogonal to said second axis and in a common plane with said first axis,
a pivot point of said ball joint formed by said first and second halves of said ball joint being arranged with an offset to said rotary axis of said first connection between said first half of said ball joint and said central connector member and to said rotation axis of said shaft,
wherein said inner piece extends through said first or said second opening, respectively, and said fourth connection, rotary around said second axis, is placed within said jacket.

2. The constant velocity universal joint of claim 1, wherein in each of said first and second joint halves said first half of said ball joint has a ball and said second half of said ball joint has a socket eccentric to said rotation axis of said shaft.

3. The constant velocity universal joint of claim 2, wherein in each of said first and second joint halves said second half of said ball joint has a trunnion and is inserted with said trunnion into a bore of said shaft.

4. The constant velocity universal joint of claim 1, wherein said jacket is a cylindrical element.

5. The constant velocity universal joint of claim 4, wherein in each of said first and second joint halves said inner piece has a pair of trunnions on said second axis and wherein said jacket has bores for accommodating said trunnions of said inner pieces.

6. The constant velocity universal joint of claim 4, wherein said central connector member has a pair of first symmetric bores along said second axis and a pair of second symmetric bores along said rotary axis of said first connection of said first half of said ball joint with said central connector member, wherein said second symmetric bores are part of said first connection of said first half of said ball joint and said first symmetric bores are part of said fourth connection rotary around said second axis.

7. The constant velocity universal joint of claim 4, wherein said central connector member has a pair of first symmetric bores along said second axis and a pair of second symmetric bores along said rotary axis of said first connection of said first half of said ball joint with said central connector member, wherein said second symmetric bores are part of said first connection of said first half of said ball joint and said first symmetric bores are part of said fourth connection rotary around said second axis, wherein in each of said first and second joint halves said first half of said ball joint has a trunnion and said trunnion is inserted into one of said second symmetric bores of said central connector member.

8. The constant velocity universal joint of claim 1 having a movement restriction for said second connection, wherein in each of said first and second joint halves said inner piece has an arm extending from said second connection into said first or second opening of said central connector member, respectively, and has a protrusion which extends diametrically opposed to said arm with respect to said first axis and said eccentric arm of said shaft has surfaces for abutting against said protrusion and said arm of said inner piece.

9. The constant velocity universal joint of claim 1, wherein in each of said first and second joint halves said second connection rotary around said first axis comprises
an eye of said inner piece,
a fork having two eyes at an end of said eccentric arm of said shaft, and
a symmetric pair of blocks, each of said blocks being inserted into said eye of said inner piece and one of said two eyes of said fork.

10. The constant velocity universal joint of claim 9, wherein each of said two eyes of said fork has a groove and a snap ring inserted into said groove and accommodates a cup of a needle bearing secured by said snap ring, wherein each of said blocks is supported in each of said eyes of said fork with said needle bearing.

11. Articulated shaft having at least one constant velocity universal joint comprising first and second joint halves and a central connector member connecting said first and second joint halves with each other, wherein said central connector member has a jacket with a first opening associated with said first joint half and a second opening associated with said second joint half, each one of said first and second joint halves comprising:
a ball joint having a first half and a second half,
said first half of said ball joint provided with a first connection with said central connector member,
a shaft with an eccentric arm which is eccentric to a rotation axis of said shaft,
an inner piece provided with a first axis and a second axis, said first and second axes being orthogonal to each other,
a second connection, rotary around said first axis, between said eccentric arm and said inner piece, wherein said rotation axis of said shaft and said first axis are arranged orthogonal to each other,
said second half of said ball joint provided with a third connection with said shaft, said third connection being rotary around said rotation axis of said shaft,
a fourth connection, rotary around said second axis, between said inner piece and said central connector member,
said first connection of said first half of said ball joint with said central connector member being rotary around a rotary axis extending orthogonal to said second axis and in a common plane with said first axis,
a pivot point of said ball joint formed by said first and second halves of said ball joint being arranged with an offset to said rotary axis of said first connection between said first half of said ball joint and said central connector member and to said rotation axis of said shaft,
wherein said inner piece extends through said first or said second opening, respectively, and said fourth connection rotary around said second axis is placed within said jacket.

12. Front axis for a motor vehicle, comprising an articulated shaft for each wheel of said front axis and for power transmission onto said wheels, said shaft having at least one constant velocity universal joint comprising first and second joint halves and a central connector member connecting said first and second joint halves with each other, wherein said central connector member has a jacket with a first opening associated with said first joint half and a second opening associated with said second joint half, each one of said first and second joint halves comprising:
a ball joint having a first half and a second half,
said first half of said ball joint provided with a first connection with said central connector member,
a shaft with an eccentric arm which is eccentric to a rotation axis of said shaft,
an inner piece provided with a first axis and a second axis, said first and second axes being orthogonal to each other,
a second connection, rotary around said first axis, between said eccentric arm and said inner piece, wherein said rotation axis of said shaft and said first axis are arranged orthogonal to each other,
said second half of said ball joint provided with a third connection with said shaft, said third connection being rotary around said rotation axis of said shaft,
a fourth connection, rotary around said second axis, between said inner piece and said central connector member,
said first connection of said first half of said ball joint with said central connector member being rotary around a rotary axis extending orthogonal to said second axis and in a common plane with said first axis,
a pivot point of said ball joint formed by said first and second halves of said ball joint being arranged with an offset to said rotary axis of said first connection between said first half of said ball joint and said central connector member and to said rotation axis of said shaft,
wherein said inner piece extends through said first or said second opening, respectively, and said fourth connection rotary around said second axis is placed within said jacket.
